(19) United States
(12) Patent Application Publication
(10) Pub. No.: US 2005/0132239 A1
(43) Pub. Date: Jun. 16, 2005

(54) Almost-symmetric multiprocessor that supports high-performance and energy-efficient execution

(76) Inventors: William C. Athas, San Jose, CA (US); Robert L. Mansfield, Fremont, CA (US); Lynn R. Youngs, Cupertino, CA (US); Michael F. Culbert, Monte Sereno, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 10/738,055

(22) Filed: Dec. 16, 2003

(51) Int. Cl. G06F 9/46

(52) U.S. Cl. 713/300

(57) ABSTRACT

One embodiment of the present invention provides a system for controlling execution of tasks in a multiprocessor system, which contains both a high-performance processor and an energy-efficient processor. Upon receiving a task to be executed on the multiprocessor system, the system determines whether to execute the task on the high-performance processor or the energy-efficient processor based on performance requirements for the task and/or energy usage considerations for the multiprocessor system. Next, the system executes the task on either the high-performance processor or the energy-efficient processor based on the determination.

### BACKGROUND

1. Field of the Invention

The present invention relates to techniques for conserving power in computer systems. More specifically, the present invention relates to an “almost-symmetric” multiprocessor system that supports both high-performance and energy-efficient execution of computational tasks.

2. Related Art

The dramatic increases in computational speed in recent years have largely been facilitated by improvements in semiconductor integration densities, which presently allow hundreds of millions of transistors to be integrated into a single semiconductor chip. This makes it possible to incorporate a large amount of computational circuitry onto a semiconductor chip. Moreover, the small circuit dimensions made possible by improved integration densities have enabled this computational circuitry to operate at greatly increased clock speeds.

Unfortunately, these increased integration densities and clock speeds have greatly increased power consumption. This increased power consumption is undesirable, particularly in battery-operated devices such as laptop computers, for which there exists a limited supply of energy. Any increase in power consumption decreases the battery life of the computing device.

Furthermore, as the circuitry consumes more power it produces more heat. This heat must somehow be removed so that the temperature within the computer circuits does not exceed a maximum operating temperature. To this end, computer systems typically include a number of heat-dissipating components, such as heat sinks, cooling fans and heat pipes to dissipate thermal energy. Unfortunately, these heat-dissipating components can significantly increase the volume and weight of a computer system, which is a problem for portable computer systems, in which volume and weight must be minimized. Furthermore, some of these components, such as cooling fans, consume extra power which additionally decreases battery life in portable computer systems.

In order to reduce power consumption, many portable computer systems enter a power conservation mode when the computer system is not busy. During this power conservation mode, the computer system operates at a reduced frequency and voltage level to minimize the amount of power consumed by the computer system, and to thereby increase battery life.

Entering a power conservation mode can increase battery life. However, note that during power conservation mode some portions of the processor must remain active. For example, a cache memory with its associated snoop circuitry remains active, as well as interrupt circuitry and real-time clock circuitry. Note that even if this active circuitry is not switching frequently, it will continue to draw power because of static leakage currents.

Using high-performance processors adds to the power consumption problem because high-performance processors consume large amounts of power in order to perform computing tasks as rapidly as possible for a given generation of integrated circuit technology. Conversely, smaller processor cores, with lower performance, can be significantly more energy-efficient than the high-performance processors.

FIG. 1 presents a histogram for a range of tasks common to a personal computer user. At the low end, near the left-hand side of FIG. 1, there are many tasks that require only a modest amount of computing performance. These tasks include text and spreadsheet editors, email handlers, and web browsers. Note that these tasks do not significantly benefit from a high-performance processor, which dissipates large amounts of power. Moreover, the rapid computing speed of a high-performance processor is not perceived by a personal computer user. Hence, performing these tasks on a processor with better energy efficiency can significantly reduce power consumption without a perceptible difference to the personal computer user.

At the high end, near the right-hand side of FIG. 1, are a number of computationally-intensive tasks. For these computationally-intensive tasks, which execute a large number of computational operations and process large data sets, the turn-around time when using energy-efficient processors can be unacceptably long. Hence, for these computationally intensive tasks, it is desirable to use a high-performance processor to perform the computations as fast as possible, at the cost of higher power dissipation.

### SUMMARY

One embodiment of the present invention provides a system for controlling execution of tasks in a multiprocessor system, which contains both a high-performance processor and an energy-efficient processor. Upon receiving a task to be executed on the multiprocessor system, the system determines whether to execute the task on the high-performance processor or the energy-efficient processor based on performance requirements for the task and/or energy usage considerations for the multiprocessor system. Next, the system executes the task on either the high-performance processor or the energy-efficient processor based on the determination.

In a variation on this embodiment, determining whether to execute the task on the high-performance processor or the energy-efficient processor, or subsequently determining whether it is advantageous to move the task between the high-performance processor and the energy-efficient processor, can involve considering a number of factors. These factors include: whether the task has been tagged to execute on the high-performance processor; whether the multiprocessor system is currently operating on battery power; the current workload of the energy-efficient processor; and the current thermal condition of the high-performance processor.

In a variation on this embodiment, executing the task on the high-performance processor involves determining whether the high-performance processor is powered on. If not, the system powers on the high-performance processor.

In a variation on this embodiment, if the task is executed on the high-performance processor, the system determines whether it is advantageous to move the task to the energy-efficient processor. If so, the system moves the task to the energy-efficient processor.

In a further variation, after moving the task to the energy-efficient processor, the system determines whether the high-performance processor is executing any other tasks. If not, the system powers down the high-performance processor. Powering down the high-performance processor can involve flushing cache entries from the high-performance processor, and then powering off the high-performance processor. Alternatively, powering down the high-performance processor can involve moving the high-performance processor into a deep sleep state, in which the contents of caches are preserved, but other portions of the high-performance processor are powered off.

In a variation on this embodiment, if the task is executed on the energy-efficient processor, the system determines whether it is advantageous to move the task to the high-performance processor. If so, the system moves the task to the high-performance processor. Note that determining whether it is advantageous to move the task to the high-performance processor can involve considering whether the task is taking too long to execute on the energy-efficient processor.

In a variation on this embodiment, the multiprocessor system supports a cache coherence protocol, which ensures that cache entries within the energy-efficient processor remain coherent with cache entries within the high-performance processor.

In a variation on this embodiment, the energy-efficient processor and the high-performance processor are “almost symmetric,” which means that they execute identical instruction sets and are consequently able to execute the same tasks, but provide different levels of performance. Moreover, the energy-efficient processor and the high-performance processor are both able to run the operating system.

In a variation on this embodiment, the energy-efficient processor is integrated onto a bridge chip, which additionally contains core logic circuitry that ties together and coordinates operations of components in the multiprocessor system.

In a variation on this embodiment, the high-performance processor is located on a dedicated processor chip, which contains one or more processor cores.

In a variation on this embodiment, the high-performance processor and the energy-efficient processor are located the same semiconductor chip.

In a variation on this embodiment, determining whether to execute the task on the high-performance processor or the energy-efficient processor involves initially executing the task on the energy-efficient processor, and subsequently moving the task to the high-performance processor if the task takes too long to execute on the energy-efficient processor.

### BRIEF DESCRIPTION OF THE FIGURES

FIG. 1 presents a histogram of computational demand for a number of computational tasks.

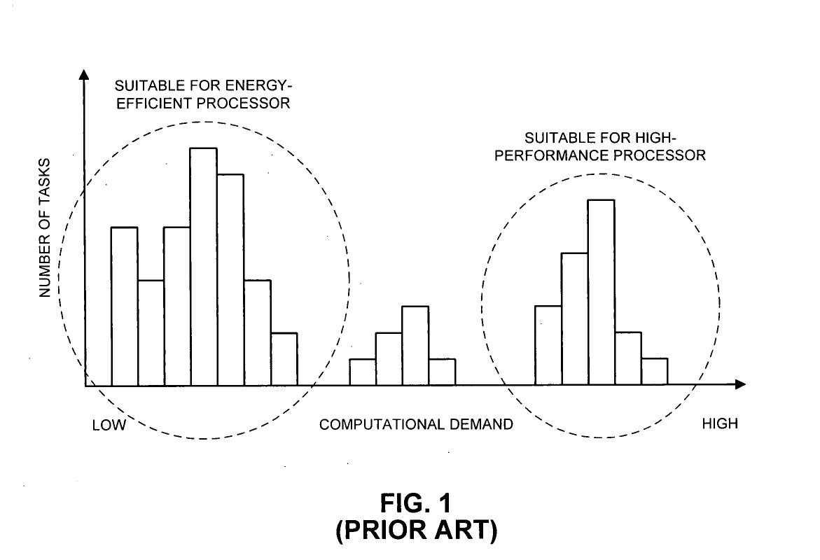

FIG. 2 illustrates a multiprocessor system with both a high-performance processor and an energy-efficient processor in accordance with an embodiment of the present invention.

FIG. 3 illustrates a multiprocessor system with both a high-performance processor and an energy-efficient processor in accordance with another embodiment of the present invention.

FIG. 4 presents a flowchart illustrating how a computational task is executed in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Multiprocessor System

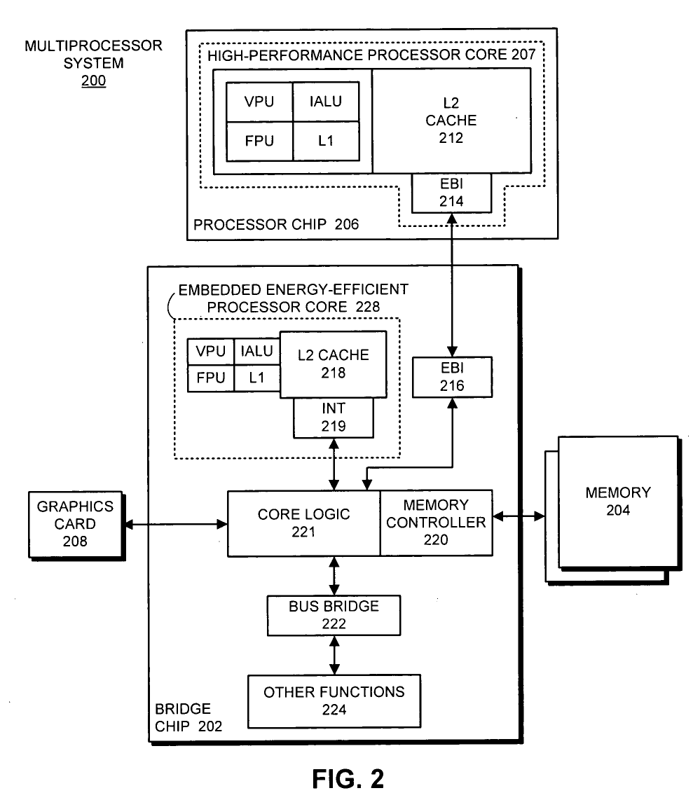

FIG. 2 illustrates a multiprocessor system 200 with both a high-performance processor and an energy-efficient processor in accordance with an embodiment of the present invention. As illustrated in FIG. 2, multiprocessor system 200 includes a bridge chip 202 and a processor chip 206. Processor chip 206 can include one or more high-performance processor cores. For example, in FIG. 2 processor chip 206 includes a single high-performance processor core 207 with a number of functional units, including a vector-processing unit (VPU), a floating-point unit (FPU), and an integer arithmetic logic unit (IALU). High performance processor core 207 also includes a level-one (L1) cache (which can include separate instruction and data caches), and a level-two-cache 212. High performance processor core 207 additionally includes an external bus interface (EBI) 214, which supports cache-coherency operations with other processors in multiprocessor system 200.

Bridge chip 202 can include any type of circuitry that couples together and coordinates operations of components within multiprocessor system 200. Note that bridge chip 202 includes an embedded energy-efficient processor core 228. Like high-performance processor core 207, this energy-efficient processor core 228 includes functional units, such as a VPU, an FPU, and an IALU. (Note that the energy-efficient processor core 228 can provide complete hardware support, partial hardware support, or no hardware support for VPU and FPU functions. Moreover, note that VPU and FPU functions that are not supported by hardware can be performed indirectly through software.)

Energy-efficient processor core 228 similarly includes an L1 cache and an L2 cache 218, as well as an interface 219 that supports cache coherency operations. However, these functional units and caches are considerably smaller, and have less performance than, corresponding functional units and caches in the high-performance processor core 207. They also consume considerably less power.

Bridge chip 202 also includes a core logic unit 221, which couples together a number of system components. In particular, core logic unit 221 is coupled to energy-efficient processor core 228, graphics card 208 and memory controller 220. (Note that memory controller 220 is additionally coupled to memory 204.) Core logic unit 221 is also coupled through bus bridge 222 to circuitry within bridge chip 202, which performs other functions 224. Core logic unit 221 is additionally coupled to high-performance processor core 207 on processor chip 206 through EBI 216.

Note that energy-efficient processor core 228 and high-performance processor core 207 share data and synchronize their interactions through coherent caches that perform cache coherency operations. These cache coherency operations are well-known in the art and will not be discussed further in this specification.

In one embodiment of the present invention, energy-efficient processor core 228 and high-performance processor core 207 are “almost symmetric,” which means that they execute identical instruction sets and are consequently able to execute the same tasks, but provide different levels of performance. Moreover, both energy-efficient processor core 228 and high-performance processor core 207 are capable of running the operating system.

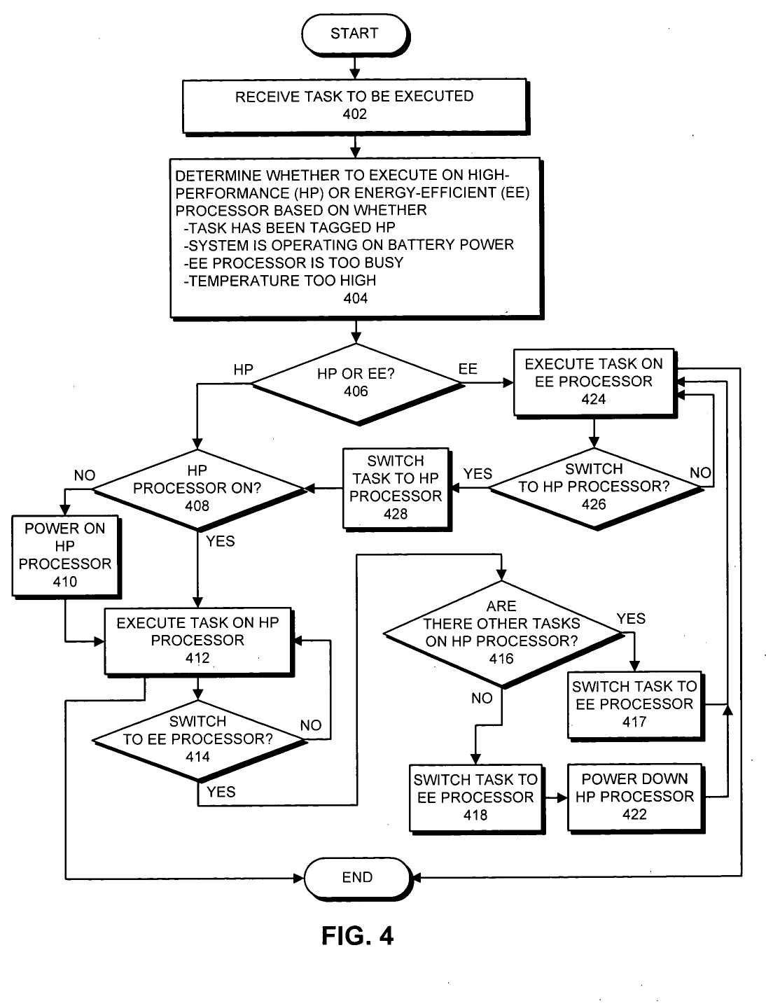

Note that an operating system for multiprocessor system 200 selectively executes computational tasks on either energy-efficient processor core 228 or high-performance processor core 207. This selective execution process is described in more detail below with reference to FIG. 4.

Alternative Embodiment of Multiprocessor System

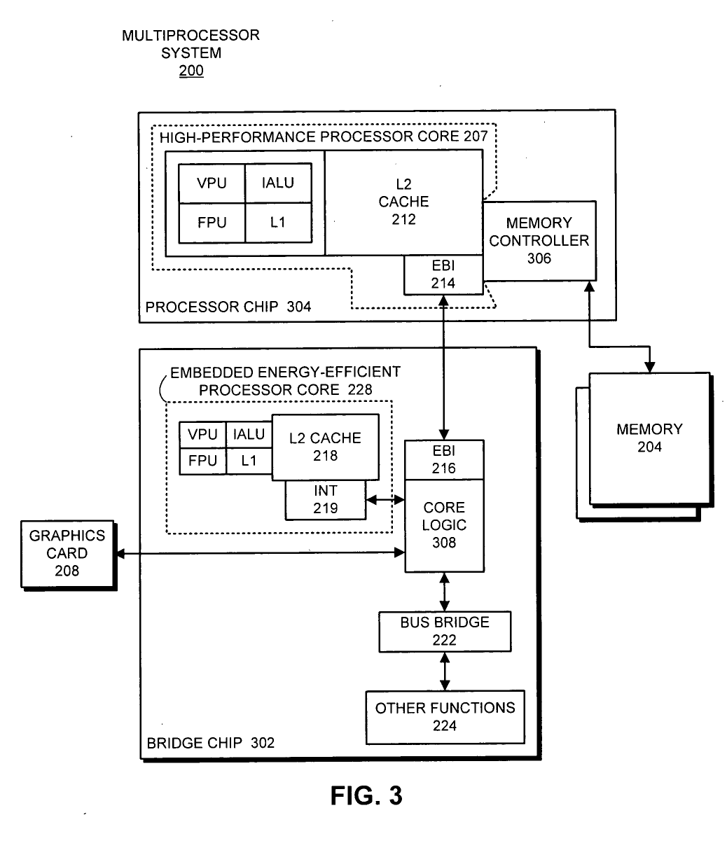

FIG. 3 illustrates a multiprocessor system 300 with both a high-performance processor and an energy-efficient processor in accordance with another embodiment of the present invention. This multiprocessor system 300 is the same as multiprocessor system 200 illustrated in FIG. 2, except that the memory controller 306 is now located in processor chip 304. This makes it possible for high-performance processor core 207 to more quickly access memory 204. However, this means that processor chip 304 becomes a necessary component of multiprocessor system 300. In contrast, in multiprocessor system 200 in FIG. 2, note that it is possible to operate the system using only energy-efficient processor core 228, without high-performance processor core 207 on processor chip 206.

Referring back to FIG. 3, bridge chip 302 is the same a bridge chip 202 in FIG. 2, except that it replaces the memory controller with core logic circuitry 308. This core logic circuitry 308 ties together graphics card 208, energy-efficient processor core 228, high-performance processor core 207 and other functions 224. Note that memory 204 is not coupled to bridge chip 302, but is instead coupled to memory controller 306 in processor chip 304.

In yet another embodiment of the present invention, the high-performance processor core 207 and the energy-efficient processor core 228 are located on the same semiconductor chip.

Execution of a Computational Task

FIG. 4 presents a flowchart illustrating how a computational task is executed in accordance with an embodiment of the present invention. Upon receiving a task to be executed (step 402), the system determines whether to execute the task on a high-performance processor or an energy-efficient processor (step 404). This determination can be based on one or more of a number of factors, including but not limited to: (1) whether the task has been tagged by a programmer, by the operating system, or by a user to execute on the high-performance processor; (2) the current workload of either or both processors, including whether the multiprocessor system is currently operating on battery power, and if so whether sufficient battery life remains to execute the task on the high-performance processor; (3) whether the energy-efficient processor is currently too busy to execute the task; and (4) the present thermal condition of wither or both processor, including whether the multiprocessor system is currently running at too high of a temperature to execute the task on the high-performance processor. Those skilled in the art will recognize that other variations of the physical integration of these components are also within the scope of the invention. For example, the processors can be integrated on physically separate or unified integrated circuit devices.

In an alternative embodiment of the present invention, the system initially executes the task on the energy-efficient processor, and subsequently moves the task to the high-performance processor if the task takes too long to execute on the energy-efficient processor.

If the system determines that it is advantageous to execute the task on the high-performance processor, the system first determines if the high-performance processor is turned on (step 408). If not, the system powers on the high-performance processor (step 410). Next, the system executes the task on the high-performance processor (step 412). If the task completes, the process is done.

Otherwise, the system periodically determines whether it is advantageous to switch the task to execute on the energy-efficient processor (step 414). This determination can be based on the factors that were initially used to determine which processor to execute the task on in step 404. Additionally, this determination can be based upon whether the high-performance processor is keeping busy executing the task, or whether the high-performance processor is spending a large amount of time in the idle loop. If the system determines it is not advantageous to switch, the system returns to step 412 to continue executing the task on the high-performance processor.

Otherwise, in order to switch the task, the system first determines whether or not other tasks are executing on the high-performance processor (step 416). If so, the system merely switches the task to execute on the energy-efficient processor (step 417). Note the process of switching a task between processors is well-understood for cache-coherent symmetric multiprocessor systems. Hence, the process of switching a task between processors will not be discussed further in the specification. After the task is switched, it resumes execution on the energy-efficient processor (step 424).

On the other hand, if no tasks remain on the high-performance processor, the system switches the task to execute on the energy-efficient processor (step 418), and then powers down the high-performance processor to reduce power consumption in the multiprocessor system (step 422). The system then resumes execution of the task on the energy-efficient processor (step 424). Note that powering down the high-performance processor can involve flushing cache entries from the high-performance processor, and then powering off the high-performance processor. Alternatively, powering down the high-performance processor can involve moving the high-performance processor into a deep sleep state, in which the contents of caches are preserved, but other portions of the high-performance processor are powered off.

If at step 406 the system determines that it is advantageous to execute the task on the energy-efficient processor, the system commences executing the task on the energy-efficient processor (step 424). If the task completes, the process is done.

Otherwise, the system periodically determines whether it is advantageous to switch the task to execute on the high-performance processor (step 426). This determination can be based on the factors that were initially used to determine which processor to execute the task on in step 404. Additionally, this determination can be based upon whether a task is taking too long to execute on the energy-efficient processor. If the system determines it is not advantageous to switch, the system returns to step 424 to continue executing the task on the energy-efficient processor.

Otherwise, the system switches the task to execute on the high-performance processor (step 428). In order to switch the task, the system first proceeds to step 408 to turn on the high-performance processor, if necessary before commencing execution on the high-performance processor (step 412).

The foregoing steps can be implemented in any suitable execution control process, whether hardware or software, including a multiprocessor operating system, which for these purposes includes any system component that dynamically allocates processor resources to an executing program. The terms “energy efficient” and “high performance” do not require any particular level of efficiency or performance, but are meant to denote a relative difference between two or more processors in the same multi-processor system. As used in the claims, the term “processor” is any circuit unit that includes a processor core. One or more processors may be physically integrated on the same semiconductor chip or packaged in the same package.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method for controlling execution of tasks in a multiprocessor system, which contains both a high-performance processor and an energy-efficient processor, comprising:
receiving a task to be executed on the multiprocessor system;
determining dynamically whether to execute the task on the high-performance processor or the energy-efficient processor; and
executing the task on either the high-performance processor or the energy-efficient processor based on the determination.

2. The method of claim 1, wherein determining whether to execute the task on the high-performance processor or the energy-efficient processor involves considering performance requirements for the task and/or energy usage considerations for the multiprocessor system.

3. The method of claim 1, wherein determining whether to execute the task on the high-performance processor or the energy-efficient processor, or subsequently determining whether it is advantageous to move the task between the high-performance processor and the energy-efficient processor, involves considering at least one of the following:
whether the task has been tagged to execute on the high-performance processor;
whether the multiprocessor system is currently operating on battery power;
the current workload of the energy-efficient processor; and
the current thermal condition of the high-performance processor.

4. The method of claim 1, wherein executing the task on the high-performance processor involves first:
determining whether the high-performance processor is powered on; and
if not, powering on the high-performance processor.

5. The method of claim 1, wherein if the task is executed on the high-performance processor, the method further comprises:
determining whether it is advantageous to move the task to the energy-efficient processor; and
if so, moving the task to the energy-efficient processor.

6. The method of claim 5, wherein after moving the task to the energy-efficient processor, the method further comprises:
determining whether the high-performance processor is executing any other tasks; and
if not, powering down the high-performance processor.

7. The method of claim 6, wherein powering down the high-performance processor involves:
flushing cache entries from the high-performance processor; and
powering off the high-performance processor.

8. The method of claim 6, wherein powering down the high-performance processor involves moving the high-performance processor into a deep sleep state, in which the contents of caches are preserved, but other portions of the high-performance processor are powered off.

9. The method of claim 1, wherein if the task is executed on the energy-efficient processor, the method further comprises:
determining whether it is advantageous to move the task to the high-performance processor; and
if so, moving the task to the high-performance processor.

10. The method of claim 9, wherein determining whether it is advantageous to move the task to the high-performance processor involves considering whether the task is taking too long to execute on the energy-efficient processor.

11. The method of claim 1, wherein the method further comprises supporting a cache coherence protocol on the multiprocessor system, wherein the cache coherency protocol ensures that cache entries within the energy-efficient processor remain coherent with cache entries within the high-performance processor.

12. The method of claim 1, wherein the energy-efficient processor and the high-performance processor are “almost symmetric,” which means that they execute identical instruction sets and are consequently able to execute the same tasks, but provide different levels of performance.

13. The method of claim 12, wherein the energy-efficient processor and the high-performance processor are both able to run the operating system.

14. The method of claim 1, wherein the energy-efficient processor is integrated onto a bridge chip, which additionally contains core logic circuitry that ties together and coordinates operations of components in the multiprocessor system.

15. The method of claim 1, wherein the high-performance processor is located on a dedicated processor chip, which contains one or more processor cores.

16. The method of claim 1, wherein the high-performance processor and the energy-efficient processor are located the same semiconductor chip.

17. The method of claim 1, wherein determining whether to execute the task on the high-performance processor or the energy-efficient processor involves:
initially executing the task on the energy-efficient processor; and
subsequently moving the task to the high-performance processor if the task takes too long to execute on the energy-efficient processor.

18. A multiprocessor system that supports both high-performance and energy-efficient execution, comprising:
a high-performance processor;
an energy-efficient processor; and
an execution control process, which is configured to,
determine dynamically whether to execute a task on the high-performance processor or the energy-efficient processor, and to
execute the task on either the high-performance processor or the energy-efficient processor based on the determination.

19. The multiprocessor system of claim 18, wherein the execution control process is configured to determine dynamically whether to execute the task on the high-performance processor or the energy-efficient processor based on performance requirements for the task and/or energy usage considerations for the multiprocessor system.

20. The multiprocessor system of claim 18, wherein while determining whether to execute the task on the high-performance processor or the energy-efficient processor, the execution control process is configured to consider at least one of the following:
whether the task has been tagged to execute on the high-performance processor;
whether the multiprocessor system is currently operating on battery power;
the current workload of the energy-efficient processor; and
the current thermal condition of the high-performance processor.

21. The multiprocessor system of claim 18, wherein before executing the task on the high-performance, the execution control process is configured to:
determine whether the high-performance processor is powered on; and
if not, to power on the high-performance processor.

22. The multiprocessor system of claim 18, wherein if the task is executed on the high-performance processor, the execution control process is configured to:
determine whether it is advantageous to move the task to the energy-efficient processor; and
if so, to move the task to the energy-efficient processor.

23. The multiprocessor system of claim 22, wherein after moving the task to the energy-efficient processor, the execution control process is configured to:
determine whether the high-performance processor is executing any other tasks; and
if not, to power down the high-performance processor.

24. The multiprocessor system of claim 23, wherein powering down the high-performance processor involves:
flushing cache entries from the high-performance processor; and
powering off the high-performance processor.

25. The multiprocessor system of claim 23, wherein powering down the high-performance processor involves moving the high-performance processor into a deep sleep state, in which the contents of caches are preserved, but other portions of the high-performance processor are powered off.

26. The multiprocessor system of claim 18, wherein if the task is executed on the energy-efficient processor, the execution control process is configured to:
determine whether it is advantageous to move the task to the high-performance processor; and
if so, to move the task to the high-performance processor.

27. The multiprocessor system of claim 26, wherein determining whether it is advantageous to move the task to the high-performance processor involves considering whether the task is taking too long to execute on the energy-efficient processor.

28. The multiprocessor system of claim 18, wherein the multiprocessor system additionally includes a cache coherence mechanism, wherein the cache coherence mechanism ensures that cache entries within the energy-efficient processor remain coherent with cache entries within the high-performance processor.

29. The multiprocessor system of claim 18, wherein the energy-efficient processor and the high-performance processor are “almost symmetric,” which means that they execute identical instruction sets and are consequently able to execute the same tasks, but provide different levels of performance.

30. The multiprocessor system of claim 29, wherein the energy-efficient processor and the high-performance processor are both able to run the execution control process.

31. The multiprocessor system of claim 18, wherein the energy-efficient processor is integrated onto a bridge chip, which additionally contains core logic circuitry that ties together and coordinates operations of components in the multiprocessor system.

32. The multiprocessor system of claim 18, wherein the high-performance processor is located on a dedicated processor chip, which contains one or more processor cores.

33. The multiprocessor system of claim 18, wherein the high-performance processor and the energy-efficient processor are located the same semiconductor chip.

34. The multiprocessor system of claim 18, wherein while determining whether to execute the task on the high-performance processor or the energy-efficient processor, the execution control process is configured to:
initially execute the task on the energy-efficient processor; and to
subsequently move the task to the high-performance processor if the task takes too long to execute on the energy-efficient processor.

35. An operating system for a multiprocessor system, wherein the multiprocessor system contains both a high-performance processor and an energy-efficient processor, comprising:
a task assignment mechanism configured to determine dynamically whether to execute a task on the high-performance processor or the energy-efficient processor based on performance requirements for the task and/or energy usage considerations for the multiprocessor system; and
an execution mechanism configured to execute the task on either the high-performance processor or the energy-efficient processor based on the determination.

36. The operating system of claim 35, wherein the task assignment mechanism is configured to determine whether to execute the task on the high-performance processor or the energy-efficient processor based on performance requirements for the task and/or energy usage considerations for the multiprocessor system.

37. A bridge circuit for use in a multiprocessor system that supports both high-performance and energy-efficient execution, comprising:
(a) an energy-efficient processor;
(b) logic circuitry that ties together and coordinates operations of components of the multiprocessor system; and
(c) logic circuitry supporting a process for determining whether an executable task should be executed on the energy-efficient processor or, alternatively, on a high-performance processor.
